(19) United States
(12) Patent Application Publication
(10) Pub. No.: US 2019/0264545 A1
(43) Pub. Date: Aug. 29, 2019

(54) SYSTEM AND METHOD FOR HEALTH PREDICTION OF RIG EQUIPMENT

(71) Applicant: Schlumberger Technology Corporation, Sugar Land, TX (US)

(72) Inventors: Alejandro Camacho Cardenas, Houston, TX (US); Vishwanathan Parmeshwar, Houston, TX (US); Manat Singh, Houston, TX (US); Geir Kroslid, Kristiansand (NO); Johan Lindal Haug, Kristiansand (NO)

(21) Appl. No.: 15/903,670

(22) Filed: Feb. 23, 2018

(51) Int. Cl. E21B 41/00; G05B 15/02

(52) U.S. Cl. CPC E21B 41/0092; G05B 15/02

(57) ABSTRACT

A drilling rig health management system is used on a drilling rig site including a plurality of rig equipment for drilling rig operations. Additionally, a health management system may be located on the drilling rig site and configured to determine a health index of the plurality of rig equipment. Further, drilling rig health management system may manage a health of rig equipment at the drilling rig site by measuring a health of a plurality of rig equipment with one or more sensors, determining a health index of the plurality of rig equipment, and monitoring the health index.

### BACKGROUND

Drilling rigs include a multitude of equipment that, like many other complex mechanical and/or electrical devices, are prone to failure. Understanding the current operational status of the equipment is vital to anticipating failures. When the rig equipment fails during operation, it causes undesired costly Non-Productive Time (NPT). Additionally, equipment maintenance is normally performed on a predetermined schedule and/or when issues arise. A predetermined maintenance schedule can result in performing maintenance when it is not really needed. Since rig equipment is used on varying operations and load cycles, the rig equipment's level of wear and tear can therefore be variable. Conventional methods simply schedule maintenance activities based on time or running-time of the equipment and just track the amount or frequency of the maintenance preformed on the plurality of equipment. Otherwise, maintenance on the equipment can be scheduled when issues arise, such as, an equipment failure (i.e. the equipment cannot operate) or a component failure (e.g. leaking oil but the equipment can still operate), but the equipment failure and component failure increases the NPT.

### SUMMARY OF DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, this disclosure relates to a drilling rig health management system that may include a drilling rig site including a plurality of rig equipment for drilling rig operations. Additionally, a health management system may be located on the drilling rig site and configured to determine a health index of the plurality of rig equipment.

In one aspect, this disclosure relates to a method for managing the health of rig equipment at a drilling rig site that may include measuring a health of a plurality of rig equipment with one or more sensors, determining a health index of the plurality of rig equipment, and monitoring the health index.

Other aspects and advantages will be apparent from the following description and the appended claims.

### BRIEF DESCRIPTION OF DRAWINGS

FIG. 1 illustrates a view of a drilling rig site.

FIG. 2 illustrates a flowchart of a drilling rig health management system for a drilling rig site according to one or more embodiments of the present disclosure.

FIG. 3 illustrates a health index with static threshold values according to one or more embodiments of the present disclosure.

FIG. 4 illustrates a health index with adaptive threshold values according to one or more embodiments of the present disclosure.

FIGS. 5A-5C illustrate graph of a health index over time according to one or more embodiments of the present disclosure.

FIGS. 6A and 6B illustrate graph of a health index signature of a health index over time according to one or more embodiments of the present disclosure.

FIG. 7 illustrates a drilling rig health management system for a drilling rig site implemented on a computing system according to one or more embodiments of the present disclosure.

### DETAILED DESCRIPTION

Embodiments of the present disclosure are described below in detail with reference to the accompanying figures. Like elements in the various figures may be denoted by like reference numerals for consistency. Further, in the following detailed description, numerous specific details are set forth in order to provide a more thorough understanding of the claimed subject matter. However, it will be apparent to one having ordinary skill in the art that the embodiments described may be practiced without these specific details. In other instances, well-known features have not been described in detail to avoid unnecessarily complicating the description.

Further, embodiments disclosed herein are described with terms designating a rig site in reference to a land rig, but any terms designating rig type should not be deemed to limit the scope of the disclosure. For example, embodiments of the disclosure may be used on an offshore rig. It is to be further understood that the various embodiments described herein may be used in various rig sites, such as land rig, drilling vessel, offshore rig, etc., and in other environments, such as work-over rigs, fracking installation, well-testing installation, oil and gas production installation, without departing from the scope of the present disclosure. The embodiments are described merely as examples of useful applications, which are not limited to any specific details of the embodiments herein.

Many rigs operate with a plurality of equipment (i.e., surface equipment) disposed around a rig site to perform a wide variety of operations during a life of a well (i.e., rig site preparation to drilling to completion to abandonment). At the rig, there is a wide variety of equipment for operating the rig and drilling, such as, for example, pumps, mixers, chokes, pipe handlers, motors, generators, blowout preventers, separators, top drives, waste management, etc. Additionally, for a land rig, there is also equipment for ground clearing and removal of vegetative cover, grading, vehicular and pedestrian traffic, construction and installation of facilities, excavation/blasting for construction materials (sands, gravels), access road and storage area construction, and construction of gathering pipelines and compressor or pumping stations. The plurality of equipment encompasses a number of components that are durable, sensitive, complex, simple components, or any combination thereof. Furthermore, it is also understood that one or more of the rig equipment may be interdependent upon other components. For example, as one piece of equipment suffers or fails, another may have to work twice as hard. Thus, the equipment on the rig is not all isolated pieces of equipment, and the health of one piece of equipment may impact the health of another. Once the rig is set up, typically, the rig site is capable of operating 24 hours a day. As such, the plurality of equipment needs to be in working condition to avoid NPT on the rig site. The plurality of equipment is subject to a wide variety of elements from beginning stored to being used beyond factory tolerances, and thus, a health of the plurality of equipment is a concern to avoid NPT. For example, there are concerns that rig equipment can fall victim to fatigue and stress to consequently cause a failure on the rig equipment.

Further, embodiments disclosed herein are described with terms designating a drilling rig site in reference to a drilling rig, but any terms designating rig type (i.e., any land rig or offshore rig) should not be deemed to limit the scope of the disclosure. It is to be further understood that the various embodiments described herein may be used in various stages of a well, such as rig site preparation, drilling, completion, abandonment etc., and in other environments, such as work-over rigs, fracking installation, well-testing installation, oil and gas production installation, without departing from the scope of the present disclosure. The embodiments are described merely as examples of useful applications, which are not limited to any specific details of the embodiments herein.

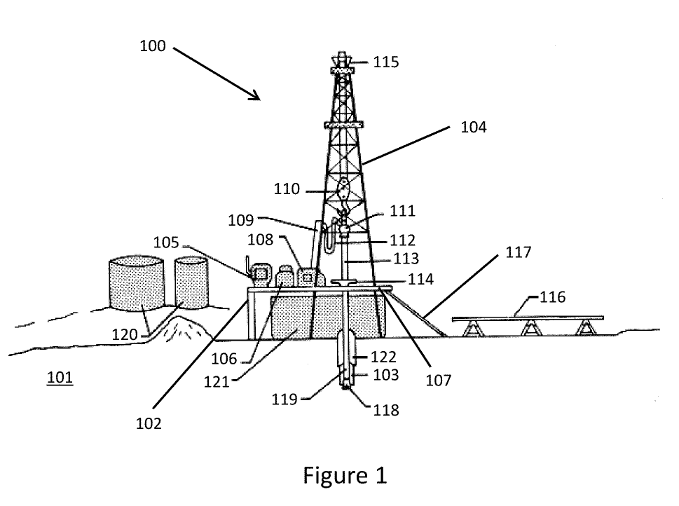

As shown in FIG. 1, a drilling rig system 100 is at a drilling rig site 101. The drilling rig system 100 includes a plurality of rig equipment for drilling rig operations. For example, a substructure 102 of the drilling rig system 100 is located and leveled over a borehole 103 of a well 122. A mast or derrick 104 is raised over the substructure 102, and the substructure 102 further holds other equipment such as engines 105 and pumps (i.e., mud pumps 106) on a rig floor 107. Additionally, rotating and hoisting equipment are aligned and connected on the substructure 102, such as, drawworks 108, standpipe 109, traveling block 110, swivel 111, rotary hose 112, kelly 113, turntable/rotary table 114, and crown/crown block 115. Further, drill pipe and drill collars are laid out on pipe racks 116 convenient to travel on a pipe ramp 117 to the rig floor 107 so that they may be hoisted up when needed and connected to a drill bit 118 or added to drill string 119. Furthermore, the drilling rig site 101 may include tanks 120 for water and fuel as well as mud pits 121. While not shown by FIG. 1, one of ordinary skill in the art would understand the drilling rig site 101 may include further equipment, such as, a wellhead, blowout preventer (BOP), fracking equipment, completions equipment, housing for workers, electronics, topdrive, automated pipe handling equipment, etc. Further, the drilling rig site 101 include a wide variety of equipment for different uses; and thus, for the purposes of simplicity, the terms “plurality of rig equipment” or “rig equipment” are used hereinafter to encompass the wide variety equipment used on the drilling rig site 101.

Additionally, the plurality of rig equipment may be exposed to a wide variety of stresses, which may generate various effects to the plurality of rig equipment. For example, the plurality of rig equipment may be used at, below, or above factory tolerances which fatigue the plurality of rig equipment, exposed to weather conditions which wear/damage the plurality of rig equipment, stored for extended period of times, or any element that may damage the plurality of rig equipment know in the art used at the drilling rig site 101. As such, the drilling rig site 101 may generate excessive and/or constant stress that has unknown (and possibly ill) effects on the plurality of rig equipment that cause a number of short and long-term health issues, such as reduced work performance, failures, stalls, increased NPT and more. Further, the drilling rig site 101 may become compromised and may even become dangerous for workers on site when the health of the plurality of rig equipment decreases.

Having a drilling rig site with a health management system can bring a tremendous competitive advantage on rig safety, overall performance of the rig, reduced risk of NPT and many other advantages. Embodiments of the present disclosure describe measurements, control systems and strategies to measure and monitor a health of the plurality of rig equipment. For example, in one or more embodiments, health management system may determine a health index of the plurality of rig equipment.

Embodiments of the present disclosure may be directed to systems and methods to measure, determine and monitor the health of the plurality of rig equipment at the drilling rig site to ensure the plurality of rig equipment is in working condition. That is, when the plurality of rig equipment is at the drilling rig site, a health management system determines a health index of the plurality of rig equipment. Further, the health management system compares the health index to threshold values to determine a health of the plurality of rig equipment. Thus, the health management system may change a usage of the plurality of rig equipment based on the health of the plurality of rig equipment. It is further envisioned when multiple wells are drilled with multiple drilling rig sites, the health management system may be deployed in a large area or at each drilling rig system to cover a plurality of rig equipment over large distances. With such process, the corresponding equipment condition (i.e., health of the plurality of rig equipment) of all drilling rig systems are determined and monitored at the health management system. As such, health management system manages collected information of the health of the plurality of rig equipment to trigger an appropriate action (e.g., reduce/stop using the plurality of rig equipment, schedule repairs, etc.). In conventional operations, drilling rig systems simply use equipment maintenance at predetermined schedules and/or when issues arise with the plurality of rig equipment. In contrast, embodiments of the present disclosure provide a health management system to determine and monitor a health index of the plurality of rig equipment in real time to reduce or eliminate NPT with a more scientific approach, thus presenting significant safety improvements to the drilling rig site and improved performance of the drilling rig site, for example. It is further envisioned that the embodiments of the present disclosure may further use a Prognostics and Health Management (PHM) for the prediction of failures of equipment and decide when maintenance should be done to prevent downtime without departing from the scope of the present disclosure. As discussed herein, measuring, determining, and monitoring the health condition of a plurality of rig equipment at a drilling rig site by a health management system of the drilling rig site are all envisioned as being embodiments of the present disclosure.

Various embodiments that allow for health management system to be used are envisioned and such embodiments may be used at any stage of the well in which the drilling rig system is being employed, moving, or no longer at the well. For example, the health management system can be deployed during the initial rig-up of a rig, throughout the drilling operations, as the rig is moving from one well to another well, and/or on beam pump systems which are used at the completion of the well. Thus, the health management system may be attached to either be temporally or permanently with or without the drilling rig. Additionally, the health management system may be adjusted to be accommodating to the drilling rig system during different stages of the well's life.

Further, embodiments disclosed herein are described with terms designating in reference to a health of a plurality of rig equipment, but any terms designating should not be deemed to limit the scope of the disclosure. For example, the health of the plurality of rig equipment may include any type of wear and/or failure and may have any part/component of the plurality of rig equipment. It is to be further understood that the various embodiments described herein may be used with various types of usage of the plurality of rig equipment, including but not limited to storing the equipment to running the equipment at any capacity, without departing from the scope of the present disclosure.

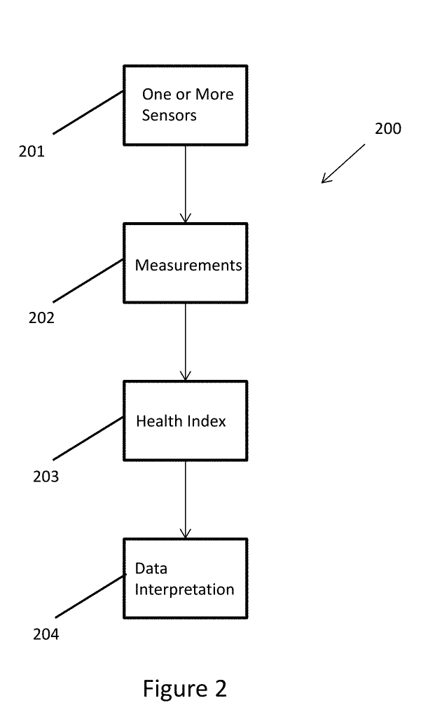

With reference to FIGS. 2-6B, this disclosure describes systems and methods of how a health management system (HMS) determines and monitors a health index. In some embodiments, the HMS is used at the drilling rig site (though, there is no requirement that all parts of HMS be physically located at the drill site) to monitor a health condition of the plurality of rig equipment. The HMS may use a wide variety data collecting and comparisons determine the health index of the plurality of rig equipment to identify an appropriate action (i.e., maintain status quota, stop operations, schedule repairs, replace equipment, etc.). One skilled in the art will appreciate how the HMS may be able to achieve increased rig safety, decreased NPT, better rig performance, and improved equipment life and maintenance

Referring to FIG. 2, in one or more embodiments, a system flow chart of the HMS 200 deployed at a drilling site is shown. The HMS 200 includes one or more sensors 201 may be disposed in and/or on a plurality of rig equipment to measure health data. Further, it is also understood that depending on the piece of rig equipment (and its usage and/or failure modes), different numbers and/or types of sensors may be used. For example, the one or more sensors 201 may be a microphone, ultrasonic, ultrasound, sound navigation and ranging (SONAR), radio detection and ranging (RADAR), acoustic, piezoelectric, accelerometers, temperature, pressure, weight, position, or any known sensor in the art to detect changes to the plurality of rig equipment. For example, the one or more sensors 201 are located on relevant rig equipment on locations where they can gather data and be able detect any damage/wear of the plurality of rig equipment to derive health data. For example, an engine at a rig site may have a sensor disposed on the outer surface thereof, as well as, a sensor on a piston within the engine. Further examples may be a drawwork disposed on a rig floor have a sensor disposed on the outer surface thereof, as well as, a sensor on an electric motor within the drawwork or a sensor may be disposed on a topdrive to measure the bearings of the topdrive. It is further envisioned that pressure lines going to several pieces of rig equipment may be measured in a central location, such that, the sensor(s) connected to the pressure lines measures multiple pieces of equipment. The health data gathered from the one or more sensors 201 may include measurements 202, such as: progressing unfavorable equipment behavior (e.g. escalating or dropping temperature, changing pressures, etc.), wear on the equipment progressing to or past factory tolerances, outside elements impacting the equipment, rust build up on the equipment, detecting usage of the equipment, damage to internal components of the equipment, and equipment failure. Additionally, one of ordinary skill in the art will appreciate how the present discourse is not limited to just the measurements 202 listed above and may include any effects on the plurality of rig equipment. The measurements 202 produced by the one or more sensors 201 become part of the information needed for health analysis of the plurality of rig equipment. It is further envisioned that measurements 201 can be used independently or aggregated into compound measurements (e.g. two or more measurements are combined into a single parameter). Thus, embodiments of the present disclosure may also be directed at the use of analog circuits or digital signal processing to aid the one or more sensors 201. Adaptive algorithms are designed to analyze the data gathered from the one or more sensors 201. Based on information generated from the adaptive algorithms, the one or more sensors 201 will generate a signal that will be communicated to the HMS 200. It is further envisioned that the one or more sensors 201 may communicate through any means such as wirelessly, through fiber optics, or copper wires to send the gather information to the HMS 200. Further, the data from such sensors may make measurements in a scheduled basis or on command, or a combination thereof.

Still referring to FIG. 2, the measurements 202 from the one or more sensors 201 are cataloged to create a health index 203 of the plurality of rig equipment. The health index 203 may include, for example: a direct value of a single measurement or the direct value of an aggregated measurement, derived from measurement(s) at an individual time or during a time span, an output of a mathematical model, or the combination thereof. In one example, the health index 203 may be an expected operating temperature of the rig equipment during the operation with known or measured conditions. It is further envisioned that the health index 203 can be single health index or multiple health indices for any given plurality of rig equipment on a drilling rig site. For example, it is envisioned that a single piece of equipment may have multiple health indices for multiple components of the single piece of equipment. Further, it is also envisioned that multiple pieces of equipment may be grouped together for purposes of a health index such a health index for a sub-system or system (having multiple pieces of equipment therein) may be considered. Moreover, it is also understood that for a given piece of equipment, there may exist health indices at different levels of the equipment hierarchy (such as one or more health indices at a component level, a health index at the equipment level, and one or more health indices at the sub-system and system level). Additionally, the health index 203 may be captured, reported and/or stored at any point of a life-cycle of the plurality of rig equipment. The life-cycle of the plurality of rig equipment may include, for example: engineering design and qualification (V&V), factory testing, rig commissioning, rig operations, maintenance, troubleshooting, and disposal. It is understood that the health data may include data that is measured by the sensors prior to the connection of the equipment to the health management system. In such instances, it is envisioned that the data may be stored locally and conveyed to the health management system upon connection of the equipment thereto. Additionally, the HMS 200 uses the health index 203 to perform a data interpretation 204 for health management. The data interpretation 204 may include an evaluation of the health index value and/or a health index signature. Such evaluation may use adaptive algorithms designed to use the evaluations to establish (and/or compare against) threshold values, change the usage of the equipment, alert the rig site (or operator thereof) of potential/actual failures, etc. It is further envisioned that the HMS 200 may be accessed and run from an existing control systems (i.e., a computer/control panel at the rig site) and include a display, as well as, allowing remote access to the HMS 200. Additionally, the HMS 200 may send the collected data to any secure location wirelessly.

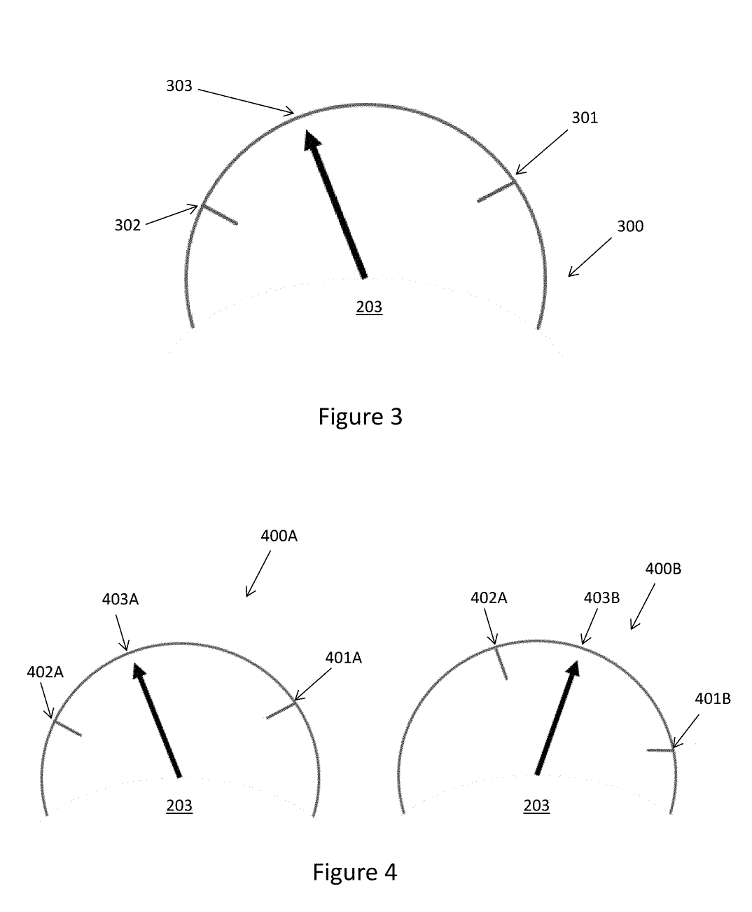

As mentioned, in one or more embodiments, the health index value may be interpreted, for example, through use of thresholds, trending, and/or extrapolation. In some embodiments, the health index 203 is tracked and threshold values are established for the plurality of rig equipment. As shown in FIG. 3, in one or more embodiments, the health index 203 is presented with static (i.e., fixed) threshold values on an odometer 300. One of ordinary skill would understand that the odometer 300 is shown for example purposes only and the present disclosure is not limited to placing the health index on an odometer and may be plotted on type of data collecting format. For example, the health index 203 may be presented on digital counter, a bar graph, a scatter plot, etc. The static values may include an upper limit 301, a lower limit 302, or the combination thereof. Since the upper limit 301 and the lower limit 302 are static, they do not change at any time. Additionally, the upper limit 301 and the lower limit 302 represent what are the allowable boundaries of operation for the health index 203 of the plurality of rig equipment. It is further envisioned that the allowable boundaries may be set taking into account a number of different aspects, such as the equipment limitations itself, the environmental conditions, the type of operation being performed, the other equipment's interacting with this equipment, etc. The health index 203 may be at a current health index 303 tracked by the HMS; as such, when the plurality of rig equipment is under a stress, the current health index 303 may change and move towards the upper limit 301 or the lower limit 302. It is further envisioned that the HMS may change or suggest a change of a usage of the plurality of rig equipment as the current health index 303 trends towards the upper limit 301 or the lower limit 302 of the threshold values. For example, a motor on a rig may have health index 203 based on a temperature of an oil running the motor, such that, the upper limit 301 may be set at 150° F. and the lower limit 302 may be set at 30° F. In such a case, when the current health index 303 of the oil temperature of the motor approaches 150° F. or 30° F., the HMS may automatically change a usage of the motor to keep the oil temperature within the upper limit 301 and the lower limit 302. Alternatively, the HMS may send/sound an alarm to alert a worker of the health index 203 of the oil temperature of the motor. One of ordinary skill in the art would understand the above example of the oil temperature of the motor uses one or more principles of the present disclosure and is only used for an example, as the present disclosure is not limited to the motor but rather any piece of equipment at the drilling rig site. Further, it is also understood that the thresholds themselves may be set based on the objective of the operation. For example, if the objective is to drill faster, even if it involves breaking one or more pieces of equipment, the thresholds may be set with such objective in mind.

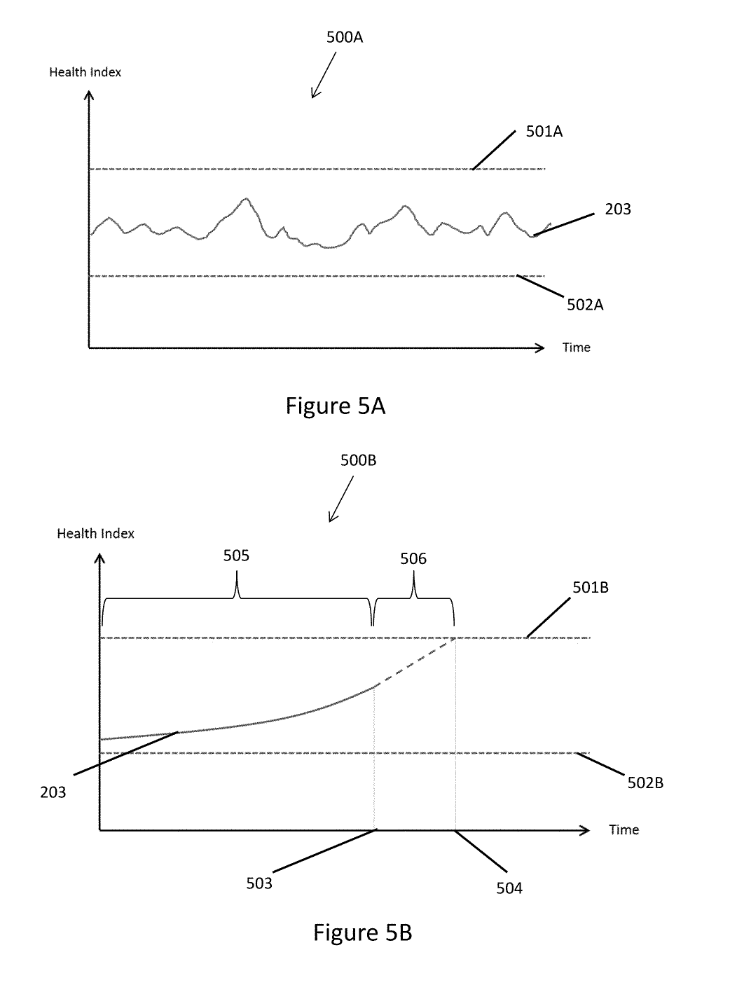

Referring to FIG. 4, the health index may have threshold values that are only applicable during certain conditions but not in other conditions, and thus, the threshold values may be adaptive according to one or more embodiments Specifically, the health of the plurality of equipment is affected in wide variety of way, such as: equipment usage (i.e., varying loads, speeds, cycles, etc.), equipment interactions (i.e., supporting equipment, other equipment, human contact, etc.), and environmental conditions (i.e., temperature, humidity, atmospheric pressure, etc.). The adaptive threshold values for the health index 203 may have a first odometer 400A for a first operation (or condition) of the rig equipment and a second odometer 400B for a second operation (or condition) of the rig equipment. The first odometer 400A includes a first upper limit 401A and a first lower limit 402A for the threshold values at the first operation (or condition). Additionally, the second odometer 400B includes a second upper limit 401B and a second lower limit 402B for the threshold values at the second operation (or condition). An example of using the adaptive threshold values is that the first condition may establish the health index 203 for when the rig equipment is idle and the second condition may establish the health index 203 for when the rig equipment is running at 50% capacity. Another example may be based on weather. For example, during summer, different thresholds may be needed than during winter, based on the difference in environmental temperatures that can impact that the health of the equipment. It is further envisioned that the HMS may have the different operations (or conditions) of the rig equipment preprogrammed (i.e., the HMS has set of conditions dictating boundaries before the rig equipment is used) or the HMS may learn the different operations (or conditions) of the rig equipment through the measuring and determining of the health index. One skilled in the art will appreciate how the HMS can track a current health index 403A at the first operation and the current health index 403B at the second operation, such that, the HMS can switch from the first odometer 400A to the second odometer 400B and vice versa in real time automatically or on command as the needs of the rig may change the usage of the rig equipment. Furthermore, the HMS may automatically change the usage of the rig equipment as the current health index (403A, 403B) is reaching the upper limit (401A, 401B) or the lower limit (402A, 402B) at both the first operation and the second operation. Alternatively, the HMS may send/sound an alarm to inform the rig site that the health index of the rig equipment is reaching or reached the threshold values, and thus, an action may be taken to avoid damage on the rig equipment. One of ordinary skill in the art would understand the above example of a first operation and second operation is only used for an example, as the present disclosure is not limited to just the first operation and second operation but rather any limitation of the rig equipment at the drilling rig site.

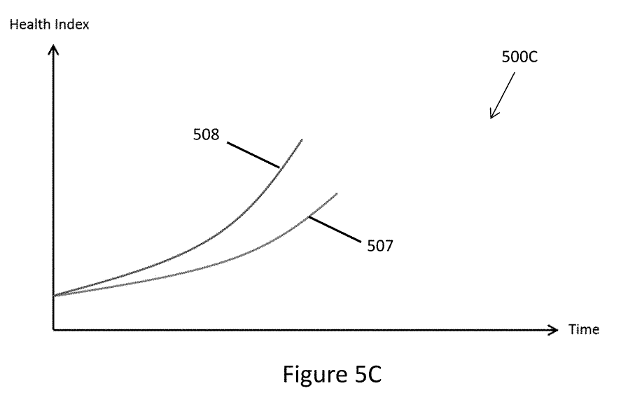

In one or more embodiments, the HMS may track the health index 203 over time, as shown by the graph 500A in FIG. 5A. The health index 203 is shown with various spikes and slopes to simulate how the health index may be variable over the life of the rig equipment as time progresses. One of ordinary skill in the art would understand the health indexes for each piece of the plurality of rig equipment may be vastly different or similar. Additionally, an upper limit 501A and a lower limit 502B of threshold values of the health index 203 may also be plotted on the graph 500A by the HMS. The information from graph 500A may be stored for later use or be used in real time to evaluate future health conditions and predict patterns of the health index 203 of the rig equipment. Additionally, by tracking the health index 203 over time, the HMS may determine the usage or accumulated wear of the plurality of rig equipment. For predicting a further health condition of the rig equipment, the HMS may extrapolate the health index 203 over time, as shown by the graph 500B in FIG. 5B. For example, a slope or varying slope of the health index 203 is tracked over time to anticipate when/if the health index 203 will breach thresholds values (static or adaptive) at an upper limit 501B and a lower limit 502B. The HMS may measure health index data to a reference time 503, and then, the HMS may use the slope or varying slope of the health index 203 to extrapolate the health index 203 to an extrapolated time 504; thus, the HMS 200 may have the graph 500B plotted with a measured health index section 505 and an extrapolated health index section 506. In some embodiments, the HMS 200 may use complex algorithms, which take into account operating, environmental, and other conditions, to determine the extrapolated health index section 506 and plot the extrapolated health index section 506 on graph 500B. Further, the HMS may base the extrapolated health index section 506 on a linear/non-linear aggregation of health index 203 over time and/or a health model (not shown) of the rig equipment. The health model, in one or more embodiments, is developed before or after the rig equipment is manufactured to encompass tolerances of the rig equipment based on engineering and design data, simulation model, performance output, dimensional requirements, and environmental conditions. In the case of the health model being developed before the equipment is manufactured, the health model is based on data from other similar equipment and/or simulation model. Additionally, the health model may then be modified (if needed) after the equipment has been manufactured to encompass the different parameters and conditions (e.g., output, tolerances etc. . . . ) of the equipment itself. One skilled in the art will apprentice how the extrapolated health index section 606 may be used to quantify how much life the rig equipment has consumed and/or how much remaining life the rig equipment has until a point of diminishing returns or failure (i.e., increased NPT). It is further envisioned that based on the trends seen in graph 500B, the HMS may automatically or on command change the usage of the rig equipped and send an alarm to signify the change. Alternatively, the HMS 200 may just send an alarm to notify the rig site that the rig equipment is in need of an adjustment. In some embodiments, it is further envisioned that the HMS may have a fail-safe protocol to shut down (immediately or stages) in an event of a dramatic or unpredicted change to the health index 203.

Now referring to FIG. 5C, the HMS may plot an expected health index 507 on a graph 500C of the health index over time. The expected health index 507 may be theoretically or known based on past experience and/or modeling of the rig equipment by the HMS or the expected health index 507 may be uploaded into the HMS. Additionally, with the HMS knowing the expected health index 507, the HMS may predict, send alerts, and/or change the usage of the rig equipment when the health index deviates from the expected health index 507. For example, the HMS may also plot a measured health index 508 on the graph 500C along with the expected health index 507. It is further envisioned that the HMS may compare the measured health index 508 versus the expected health index 507; thus, by making said comparison, the HMS is able to determine possible influences on to why the measured health index 508 deviated from the expected health index 507 at any time during the life cycle of the rig equipment. In some embodiments, the HMS may combine the graphs 500A, 500B, and 500C onto one combined graph, as described above. Further, the HMS may control a display showing the measured health index and possible trends of the health index. It is further envisioned that the HMS or the display may include variable focusing, which is the ability to widen or narrowing the health index of a certain time or operation to a focus area. The focus area may be predetermined of when the drilling rig site is performing a sensitive/critical operation (e.g., an activation of a downhole tool) or when the rig equipment is close to the threshold values (e.g., the rig equipment has been running for an extended period of time and there is a concern the rig equipment may be overworked).

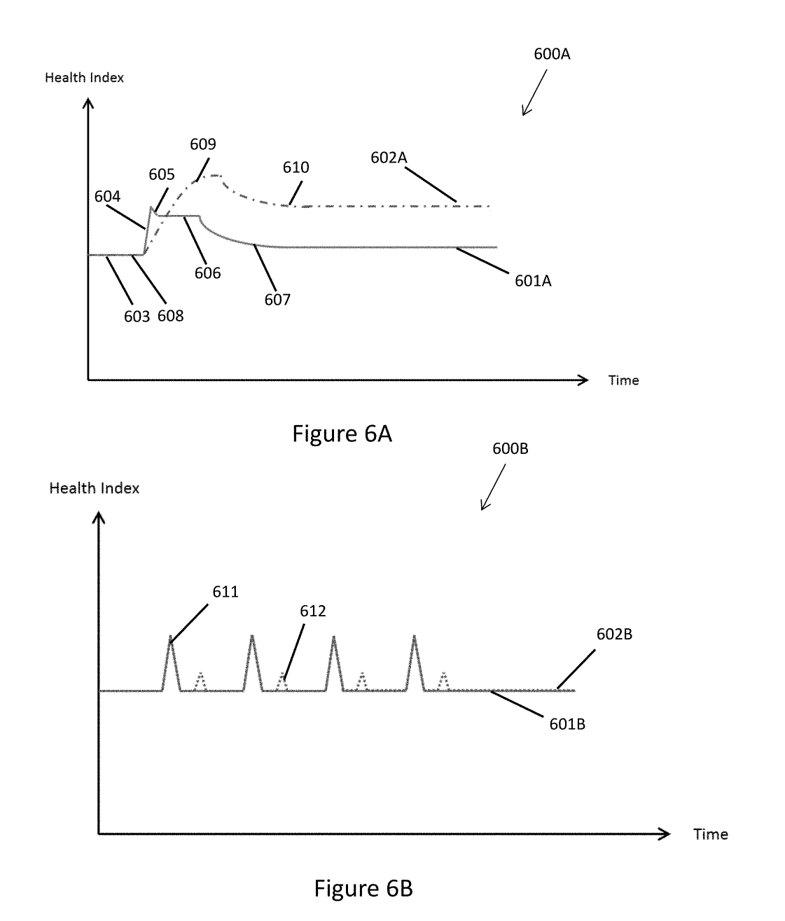

In some embodiments, the health index 203 may have a signature, which is a behavior of the health index during certain operations and/or conditions. Additionally, the signature may be known and incorporated into the HMS. While the FIGS. 3-5C may be described with respect to the health index 203, the signature of the health index may similarly be used by the HMS from the principles of the health index value 203 for management purposes. Thus, the same aspects shown in FIGS. 3-5C apply, with the difference being that instead of a health index being determined, monitored and controlled by the HMS, a signature of the health index will be determined, monitored and controlled by the HMS. It is further envisioned that the HMS 200 may plot the signature on a graph 600A, 600B of the health index over time, as shown by FIGS. 6A and 6B. FIGS. 6A and 6B show an expected signature 601A, 601B and a measured signature 602A, 602B generated by the HMS. For example, the HMS plots the expected signature 601A on the graph 600A and the expected signature 601A has a first slope 603 that is constant, followed by a second slope 604 that is linear, followed by a third slop 605 that is linear, followed by a fourth slope 606 that is constant, and then a fifth slope 607 that is exponential. While the expected signature 601A is shown with five slopes, the amount or type of slopes is not limited to five but rather any amount generated to plot the expected signature of a respective health index. Additionally, the HMS plots the measured signature 602A on the graph 600A also and the measured signature 602A has a first slope 608 that is constant, followed by a second slope 609 that is parabolic, followed by a third slop 610 that is exponential. One of ordinarily skill in the art would understand that the measured signature 602A is only shown with three slopes for examples purpose only as the measured signature 602A is defined by the health index of the plurality of rig equipment. Another example of varying health index signatures is shown by the graph 600B of FIG. 6B. In FIG. 6B, the expected signature 601B and the measured signature 602B are very similar with the expectation being that the expected signature 601B only has large spikes 611 while the measured signature 602B has the has large spikes 610 followed by small spikes 612. With both the expected signature 601A, 601B and the measured signature 602A, 602B, the HMS may compare or cross-correlate the results to determine a health of the plurality of rig equipment. For example, in order to determine the health, the HMS may use the comparison of one or more of: values and durations of slopes, maximum and minimum values of spikes, and/or quantity of pikes and slopes.

Many of the aspects described above in this disclosure can interact with one another. For example, the HMS may plot and compare the health index, the upper and lower limit of the threshold values, and the health index signatures to be used to determine and track a health of the plurality of equipment or a single piece of equipment. As such, it is understood that many of the strategies described above to control one specific parameter of the rig equipment or the entirety of the rig equipment based on the health (i.e., usage of the equipment and/or alerting the need for maintenance/repair). Furthermore, the HMS includes using the health index, the upper and lower limit of the threshold values, and the health index signatures concurrently.

Furthermore, methods of the present disclosure may apply to all of the above described embodiments, such as in FIGS. 1-6C. Because the method may apply to any of the embodiments, reference numbers are not referenced to avoid confusion of the numbering between the different embodiments. Initially, the first step is to measure a health of a plurality of rig equipment at a drilling rig site with one or more sensors. Once the health is identified, a health management system (HMS) determines a health index of the plurality of rig equipment, and then the HMS monitors the health index. Additionally, monitoring the health index includes being able to detect a failure of the plurality of equipment and compare the health index to threshold values. The HMS may also send an alarm when the health index is at the threshold values. Further, by comparing the health index to threshold values, the HMS is able to automatically change a usage of the plurality of rig equipment when the health index is at the threshold values within the drilling rig site. Furthermore, monitoring the health index may include comparing a measured signature of the health index to an expected health index signature of plurality of rig equipment. The HMS tracks and plots the health index over time. By plotting the health index, the HMS may extrapolate a future health index from the tracked health index.

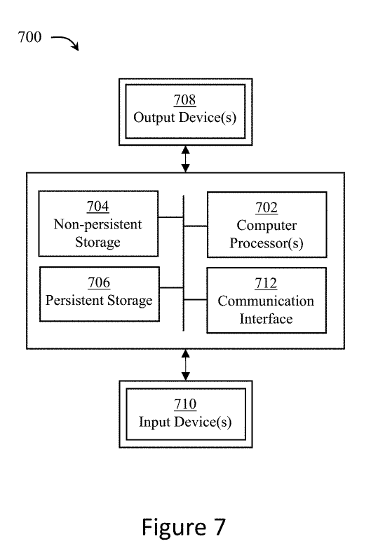

The HMS according to embodiments of the present disclosure may be implemented on a computing system. For example, an HMS may include one or more computing systems having an HMI built therein or connected thereto. Any combination of mobile, desktop, server, router, switch, embedded device, or other types of hardware may be used. For example, as shown in FIG. 7, a computing system 700 may include one or more computer processors 702, non-persistent storage 704 (e.g., volatile memory, such as random access memory (RAM), cache memory), persistent storage 706 (e.g., a hard disk, an optical drive such as a compact disk (CD) drive or digital versatile disk (DVD) drive, a flash memory, etc.), a communication interface 712 (e.g., Bluetooth interface, infrared interface, network interface, optical interface, etc.), and numerous other elements and functionalities.

The computer processor(s) 702 may be an integrated circuit for processing instructions. For example, the computer processor(s) may be one or more cores or micro-cores of a processor. Health management according to embodiments of the present disclosure may be executed on a computer processor. The computing system 700 may also include one or more input devices 710, such as a touchscreen, keyboard, mouse, microphone, touchpad, electronic pen, or any other type of input device. Additionally, it is also understood that the computing system may receive data from the sensors described herein as an input.

The communication interface 712 may include an integrated circuit for connecting the computing system 700 to a network (not shown) (e.g., a local area network (LAN), a wide area network (WAN) such as the Internet, mobile network, or any other type of network) and/or to another device, such as another computing device.

Further, the computing system 700 may include one or more output devices 708, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 702, non-persistent storage 704, and persistent storage 706. Many different types of computing systems exist, and the aforementioned input and output device(s) may take other forms.

Further, a single HMI may be provided with a computing system 700 for implementing methods disclosed herein. An HMI may include a screen, such as a touch screen, used as an input (e.g., for a person to input commands) and output (e.g., for display) of the computing system. In some embodiments, an HMI may also include switches, knobs, joysticks and/or other hardware components which may allow an operator to interact through the HMI with the drilling system.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure. More specifically, the software instructions may correspond to computer readable program code, that when executed by a processor(s) may perform one or any of the HMS features described above, including that associated with data interpretation and health management.

The computing system in FIG. 7 may implement and/or be connected to a data repository, such as a database, which may be used to store data collected from a drilling system according to embodiments of the present disclosure. Such data may include the health data described above. A database is a collection of information configured for ease of data retrieval, modification, re-organization, and deletion.

The computing system of FIG. 7 may include functionality to present raw and/or processed data, such as results of comparisons and other processing performed by an automation planner. For example, data may be presented through a user interface provided by a computing device. The user interface may include a graphical user interface (GUI) that displays information on a display device, such as a computer monitor or a touchscreen on a handheld computer device. The GUI may include various GUI widgets that organize what data is shown as well as how data is presented to a user (e.g., data presented as actual data values through text, or rendered by the computing device into a visual representation of the data, such as through visualizing a data model).

The above description of functions presents only a few examples of functions performed by the computing system of FIG. 7. Other functions may be performed using one or more embodiments of the disclosure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A drilling rig health management system, comprising:
a drilling rig site comprising a plurality of rig equipment for drilling rig operations; and
a health management system located on the drilling rig site and configured to determine a health index of the plurality of rig equipment.

2. The drilling rig health management system of claim 1, wherein the health management system comprises one or more sensors disposed in and/or on the plurality of rig equipment to measure health data.

3. The drilling rig health management system of claim 1, wherein the health management system compares the health index to threshold values to determine a health of the plurality of rig equipment.

4. The drilling rig health management system of claim 3, wherein the threshold values are static.

5. The drilling rig health management system of claim 3, wherein the threshold values are adaptive.

6. The drilling rig health management system of claim 3, wherein the health control system is configured to automatically change a usage of the plurality of rig equipment at or before the threshold values.

7. The drilling rig health management system of claim 1, wherein the health management system compares a measured signature of the health index to an expected health index signature to determine a health of the plurality of rig equipment.

8. The drilling rig health management system of claim 7, wherein the comparison includes comparison of one or more of: values and durations of slopes, maximum and minimum values of spikes, and/or quantity of spikes and slopes.

9. The drilling rig health management system of claim 1, wherein the health management system is configured to track the health index over time.

10. The drilling rig health management system of claim 9, wherein the health management system extrapolates the health index tracked over time to predict a future health index.

11. The drilling rig health management system of claim 1, wherein the health index is determined for each of the plurality of rig equipment.

12. The drilling rig health management system of claim 1, wherein the health index is determined for a combination of the plurality of rig equipment.

13. The drilling rig health management system of claim 1, wherein the health index of the plurality of rig equipment is affected by other pieces of rig equipment.

14. A method for managing the health of rig equipment at a drilling rig site, comprising:
measuring a health of a plurality of rig equipment with one or more sensors;
determining a health index of the plurality of rig equipment; and
monitoring the health index.

15. The method for managing the health of rig equipment at a drilling rig site of claim 14, wherein the monitoring comprises detecting a failure of the plurality of equipment.

16. The method for managing the health of rig equipment at a drilling rig site of claim 14, wherein the monitoring comprises comparing the health index to threshold values.

17. The method for managing the health of rig equipment at a drilling rig site of claim 16, further comprising sending an alarm when the health index is at the threshold values.

18. The method for managing the health of rig equipment at a drilling rig site of claim 16, further comprising adjusting the threshold values depending on rig operations.

19. The method for managing the health of rig equipment at a drilling rig site of claim 16, further comprising automatically changing a usage of the plurality of rig equipment when the health index is at the threshold values.

20. The method for managing the health of rig equipment at a drilling rig site of claim 14, wherein the monitoring comprises comparing a measured signature of the health index to an expected health index signature of plurality of rig equipment.

21. The method for managing the health of rig equipment at a drilling rig site of claim 14, further comprising tracking the health index over time and extrapolating a future health index from the tracked health index.
